(19) United States
(12) Patent Application Publication
(10) Pub. No.: US 2009/0179857 A1
(43) Pub. Date: Jul. 16, 2009

(54) Portable digital device with intuitive browsing function and operating method thereof

(75) Inventors: Shou-Hsiu Hsu, Taipei City (TW); Fou-Ming Liou, Taipei City (TW); Kuo-Hsun Huang, Taipei City (TW); Jia-Lin Yang, Taipei City (TW)

Correspondence Address: BACON & THOMAS, PLLC, 625 SLATERS LANE, FOURTH FLOOR, ALEXANDRIA, VA, 22314-1176, US

(73) Assignee: ASUTeK Computer Inc., Taipei City (TW)

(21) Appl. No.: 12/292,579

(22) Filed: Nov. 21, 2008

(30) Foreign Application Priority Data
Jan. 16, 2008 (TW) 097101603

(51) Int. Cl. G06F 3/033; G06F 3/01

(52) U.S. Cl. 345/157; 345/156

(57) ABSTRACT

The invention relates to a portable digital device with an intuitive browsing function and an operating method thereof. A start unit is enabled to allow the value and direction of a gravity acceleration variation to be sensed. According to the gravity acceleration variation, a sensing signal is provided for a control unit, and then the control unit operates a user interface based on the sensing signal. Therefore, users are able to operate the digital device instinctively and obtain variable operating effects by varying the displacement.

### BACKGROUND OF THE INVENTION

1. Field of the Invention

The invention relates to a portable digital device and, more particularly, to a portable digital device with an intuitive browsing function and an operating method thereof.

2. Description of the Related Art

Many conventional portable digital devices such as mobile phones and personal digital assistants have touch control interfaces for users to operate further intuitively and efficiently.

Suppliers of the portable digital devices develop many new touch technologies, and therefore, the touch control interfaces of the portable digital devices can be provided. In one mode, a multi-touch technology is used. That is, a multi-touch screen which can sense more than two touch positions at the same time is disposed on a display. In this mode, the user is not limited to that only one touch position can be sensed by a touch screen at the same time. Therefore, the user can operate the multi-touch screen with both hands at the same time to obtain a special effect. For example, when the user browses an image, he can enlarge the image by pulling outward on the image with both hands.

Another mode is that a common touch screen is combined with an application program to identify or respond to the action that a finger moves across or sweeps the touch screen. Therefore, the user also can control the touch screen via the action that the finger moves across or sweeps the touch screen besides the touch mode to enhance the functions of scrolling and browsing web pages, files, messages and contacts by fingers.

Although the above two technologies can obtain the function of operating intuitively and efficiently, the manufacture cost is very high.

### BRIEF SUMMARY OF THE INVENTION

One objective of the invention is to provide a portable digital device with an intuitive browsing function and an operating method thereof, thereby achieving the objective of intuitively browsing by moving the portable digital device.

Another objective of the invention is to provide a portable digital device with an intuitive browsing function and an operating method thereof, thereby obtaining variable operating effects by varying the displacement of the portable digital device.

To achieve the above objective, the invention provides a portable digital device with an intuitive browsing function, and the portable digital device includes a control unit, a gravity accelerometer, a display unit and a start unit. The gravity accelerometer is electrically connected to the control unit. The display unit is electrically connected to the control unit and capable of displaying a user interface. The start unit is electrically connected to the control unit. When the start unit is enabled, the gravity accelerometer continuously senses a gravity acceleration variation in a direction according to a predetermined sampling frequency to provide a sensing signal corresponding to the gravity acceleration variation for the control unit, and then the control unit operates the user interface based on the sensing signal and the displacement of the portable digital device calculated based on the gravity acceleration variation.

To achieve the above objective, the invention further provides an operating method of a portable digital device with an intuitive browsing function. The operating method includes the steps of enabling a start unit, continuously sensing a gravity acceleration variation in a direction according to a predetermined sampling frequency, providing a sensing signal corresponding to the gravity acceleration variation and operating a user interface based on the sensing signal and the displacement of the portable digital device calculated based on the gravity acceleration variation.

The user interface shows an executable object, and the control unit can execute the executable object shown by the user interface based on the sensing signal. In the embodiment of the invention, the executable object is not limited and preferred to be a menu such as a file menu or a a music menu.

The gravity accelerometer can sense at least one gravity acceleration variation in a direction. For example, the gravity accelerometer can sense gravity acceleration variations along X axis, Y axis and Z axis, sense gravity acceleration variations along two of the X axis, Y axis and Z axis and a centripetal acceleration variation along the other axis or sense the gravity acceleration variations along the X axis, Y axis and Z axis and a centripetal acceleration variation along one of the X axis, Y axis and Z axis. After the gravity accelerometer senses the gravity acceleration variations, it generates corresponding sensing signals. For example, the gravity accelerometer generates six sensing signals representing the value of the gravity acceleration variation along the positive X axis (X+), the value of the gravity acceleration variation along the negative X axis (X−), the value of the gravity acceleration variation along the positive Y axis (Y+), the value of the gravity acceleration variation along the negative Y axis (Y−), the value of the gravity acceleration variation along the positive Z axis (Z+) and the value of the gravity acceleration variation along the negative Z axis (Z−), respectively.

Therefore, as for the portable digital device with the intuitive browsing function and the operating method thereof, a start unit is enabled to allow the value and direction of the gravity acceleration variation to be sensed and provided for the control unit, and then the control unit operates a user interface based on the sensing signal. Thus, a user can operate the portable digital device intuitively and obtain various operating effects by varying the displacement of the portable digital device.

### BRIEF DESCRIPTION OF THE SEVERAL VIEWS OF THE DRAWINGS

FIG. 1 is a functional block diagram showing a portable digital device with an intuitive browsing function of a preferred embodiment of the invention;

FIG. 2A is a schematic diagram showing a portable digital device with an intuitive browsing function of a preferred embodiment of the invention;

FIG. 2B is another schematic diagram showing the portable digital device with the intuitive browsing function of the preferred embodiment of the invention;

FIG. 2C is another schematic diagram showing the portable digital device with the intuitive browsing function of the preferred embodiment of the invention;

FIG. 3 is a flow chart showing an operating method of the portable digital device with the intuitive browsing function of the preferred embodiment of the invention; and

FIG. 4 is a schematic diagram showing an operating instruction menu of a preferred embodiment of the invention.

### DETAILED DESCRIPTION OF THE EMBODIMENTS

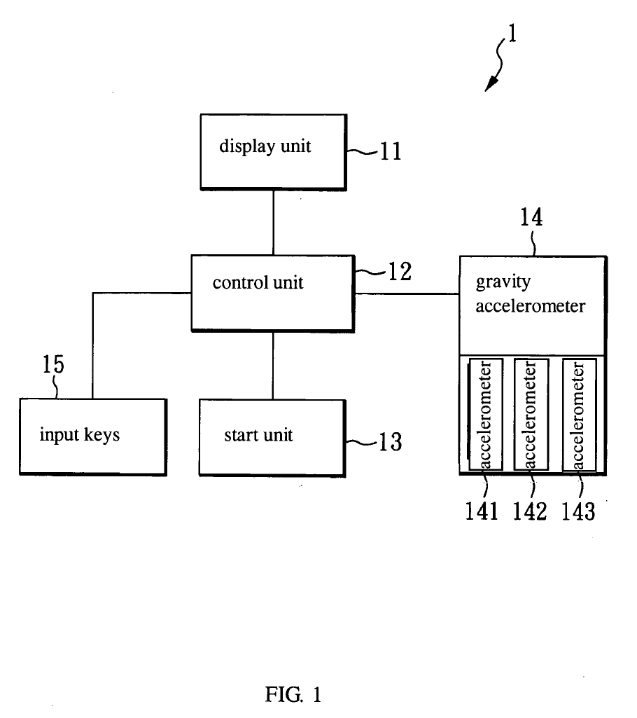

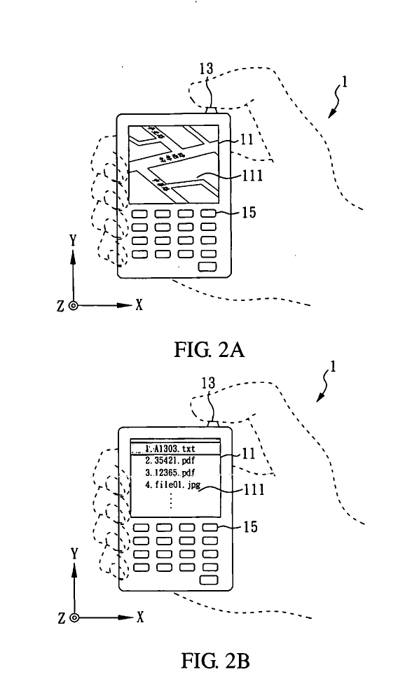

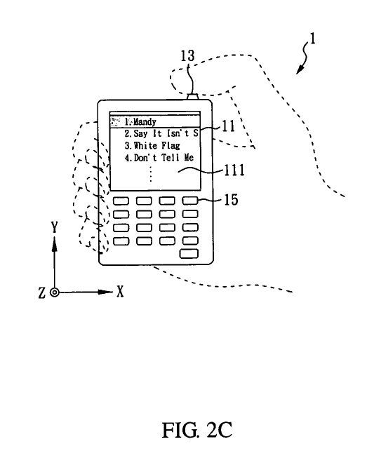

As shown in FIG. 1, FIG. 2A, FIG. 2B and FIG. 2C, FIG. 1 is a functional block diagram showing a portable digital device with an intuitive browsing function of a preferred embodiment of the invention, and FIG. 2A, FIG. 2B and FIG. 2C are schematic diagrams showing the portable digital device with the intuitive browsing function of the preferred embodiment of the invention. In FIG. 2A, the portable digital device shows a street map. In FIG. 2B, the portable digital device shows a file menu. In FIG. 2C, the portable digital device shows a music menu.

As shown in FIG. 1, a portable digital device 1 includes a display unit 11, a control unit 12, a start unit 13, a gravity accelerometer 14 and a group of input keys 15. The control unit 12 is electrically connected to the display unit 11, the start unit 13, the gravity accelerometer 14 and the input keys 15, respectively.

In the embodiment, the start unit 13 is, for example, a button is enabled by pressing to start an intuitive operating function. In other embodiments, the start unit 13 also may be a capacitive touch unit or other operating switch. For example, the start unit 13 is enabled to start the intuitive operating function when the capacitive touch unit is continuously touched.

As shown in FIG. 2A, the display unit 11 can display a user interface 111. The user interface 111 in FIG. 2A shows a street map. The user interface 111 in FIG. 2B shows a file menu. The user interface 111 in FIG. 2C shows a music menu. In FIG. 2A, the user interface 111 shows an executable object, namely the street map. The user interface 111 in FIG. 2B shows four executable objects, namely four files such as A1313.txt, 35421.pdf, 12365.pdf and file01.jpg. The user interface 111 in FIG. 2C shows four executable objects, namely four songs such as “Mandy”, “Say it isn't S . . . ”, “White flag” and “Don't tell me . . . ”

In the embodiment, the gravity accelerometer 14 may include three single-axis accelerometers 141, 142 and 143 or a triaxial accelerometer (not shown) for sensing at least one gravity acceleration variation in a direction. In the embodiment, the gravity accelerometer 14 includes the three single-axis accelerometers 141, 142 and 143. The accelerometer 141 can sense a gravity acceleration variation in X+/X− direction, the accelerometer 142 can sense a gravity acceleration variation in Y+/Y− direction, and the accelerometer 143 can sense a gravity acceleration variation in Z+/Z− direction.

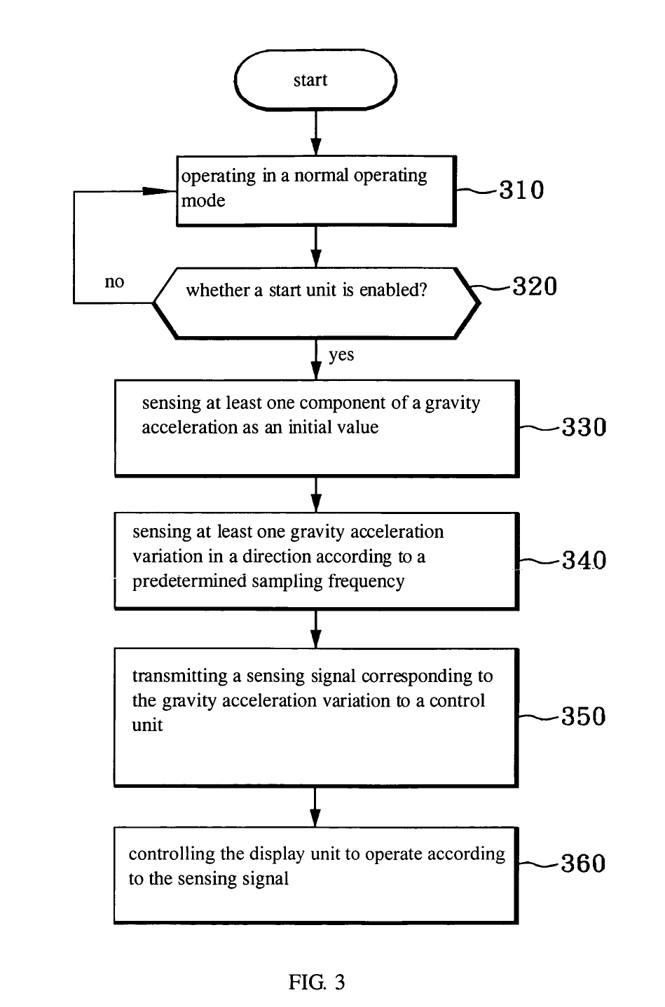

As for the operating method of the portable digital device 1, FIG. 3 is a flow chart showing the operating method of the portable digital device with the intuitive browsing function of the preferred embodiment of the invention. When the start unit 13 is disabled, the portable digital device 1 controls the display unit 11 to operate in a normal mode (the step 310). That is, the control unit 12 receives electronic signals generated by operating the input keys 15 and controls the display unit 11 to operate according to the electronic signals.

The control unit 12 continuously determines whether a user enables the start unit 13 (the step 320). When the start unit 13 is enabled, the portable digital device 1 starts the intuitive browsing function. At that moment, the accelerometers 141, 142 and 143 of the gravity accelerometer 14 sense components of the gravity acceleration in the X, Y and Z directions as initial values (the step 330).

Afterward, the gravity accelerometer 14 continuously senses the components of the gravity acceleration in the X+, X−, Y+, Y−, Z+ and Z− directions according to a predetermined sampling frequency. For example, the gravity accelerometer 14 senses the components of the gravity acceleration in the X+, X−, Y+, Y−, Z+ and Z− directions every t seconds. Then, the components of the gravity acceleration in the X+, X−, Y+, Y−, Z+and Z− directions are compared with the above obtained initial values to obtain the gravity acceleration variations (the step 340).

The gravity acceleration variations sensed at different sampling time points are different due to different rotary angles, movement directions or instant accelerations of the portable digital device at different sampling time points. For example, when the user moves the portable digital device toward the Y+ direction with an instant acceleration, a positive gravity acceleration variation is sensed in the Y+ direction. Afterward, the gravity accelerometer 14 generates six sensing signals a_{X+}, a_{X-}, a_{Y+}, a_{Y-}, a_{Z+} and a_{Z-} corresponding to the sensed gravity acceleration variations in the X+, X−, Y+, Y−, Z+ and Z− directions, respectively, and the gravity accelerometer 14 provides the six sensing signals for the control unit 12. The sensing signals a_{X+}, a_{X-}, a_{Y+}, a_{Y-}, a_{Z+} and a_{Z-} correspond to the sensed gravity acceleration variations in the X+, X−, Y+, Y−, Z+ and Z− directions, respectively (the step 350).

After the control unit 12 receives the sensing signals a_{X+}, a_{X-}, a_{Y+}, a_{Y-}, a_{Z+} and a_{Z-}, it calculates the displacements of the portable digital device 1 according to the following equations.

D_{X+}=V₀t+½a_{X+}t²;

D_{X-}=V₀t+½a_{X-}t²;

D_{Y+}=V₀t+½a_{Y+}t²;

D_{Y-}=V₀t+½a_{Y-}t²;

D_{Z+}=V₀t+½a_{Z+}t²;

D_{Z-}=V₀t+½a_{Z-}t²;

Wherein D_{X+}, D_{X-}, D_{Y+}, D_{Y-}, D_{Z+} and D_{Z-} represent the displacements of the portable digital device 1 in the X+, X−, Y+, Y−, Z+ and Z− directions, respectively, t represents time interval of sampling one time, and V₀ represents initial velocity and usually is zero.

After the control unit 12 calculates the displacements of the portable digital device 1 in the X+, X−, Y+, Y−, Z+ and Z− directions according to the above six equations, it controls the user interface 111 displayed by the display unit 11 to perform an operation such as picture rotation, picture shift, menu scrolling, cursor movement or confirmation to execute the executable objects shown by the user interface 111 according to operating instructions set by the user or the supplier. The “picture rotation” instruction is to allow the picture to be rotated, the “picture shift” instruction is to allow the picture to be shifted, the “menu scrolling” instruction is to allow the menu on the user interface 111 to scroll, the “cursor movement” instruction is to allow the cursor on the user interface 111 to move upward, downward, left or right, and the “confirmation” instruction is to input an “enter” instruction on the user interface 111. The control unit 12 can control the rotation angle of the picture, the number of times of menu scrolling, the number of times of moving the cursor or the number of times of the confirmation input according to an electrical characteristic of the sensing signal, such as the number of the sampled positive gravity acceleration variations. When the control unit 12 controls the display unit 11 to allow the picture to rotate, allow the picture to shift, allow the menu to scroll or allow the cursor to move, it can control the directions of the picture rotation, the picture shift, the menu scrolling or the movement of the cursor based on the sensing signals a_{X+}, a_{X-}, a_{Y+}, a_{Y-}, a_{Z+} and a_{Z-} corresponding to the gravity acceleration variations, and then the directions of the picture rotation, the picture shift, the menu scrolling or the movement of the cursor correspond to the gravity acceleration variations. For example, when the user moves the portable digital device 1 toward the right to allow the sensing signal a_{X+} to be positive, the user interface 111 is allowed to move right. When the user moves the portable digital device 1 downward to allow the sensing signal a_{Y+} to be positive, the menu scrolls downward. Therefore, the portable digital device 1 of the embodiment can intuitively control the user interface to operate when the user moves the portable digital device 1.

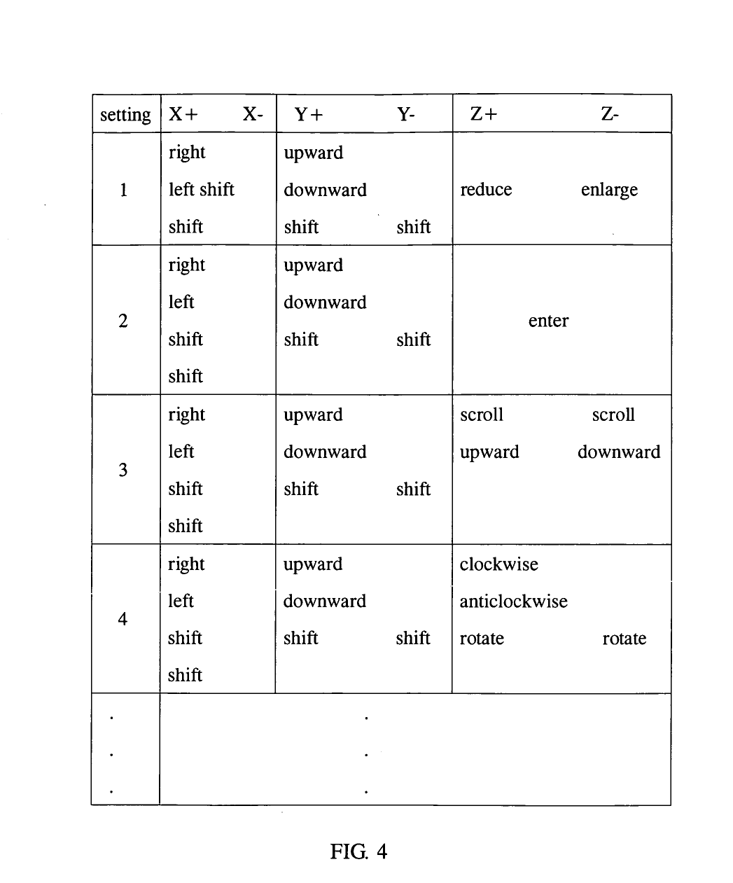

FIG. 4 is a schematic diagram showing an operating instruction menu of a preferred embodiment of the invention. As shown in FIG. 4, if the user selects the first type of operating instructions to browse the user interface 111 in FIG. 2A, after the user enables the start unit 13 and moves the portable digital device 1 by a distance D toward the X+ direction, the control unit 12 calculates the distance D_{X+} and controls the user interface 111 displayed by the display unit 11 to move by the distance D_{X+} toward the right. The distance D corresponds to the distance D_{X+}, and in the embodiment, the distance D is equal to the distance D_{X+}. Therefore, when the user moves the portable digital device 1 by various time intervals, in various directions and with various force, the gravity acceleration variations sensed at different sampling time points are different, and the control unit 12 can calculate to obtain different distances D_{X+}, D_{X-}, D_{Y+}, D_{Y-}, D_{Z+} and D_{Z-}. Then, the user interface 111 displayed by the display unit 11 can be operated according to the action of moving the portable digital device 1. For example, when the user translates the portable digital device 1 by five centimeters toward the X+ direction, the control unit 12 controls the map displayed by the display unit 11 to shift by five centimeters toward the right. When the user translates the portable digital device 1 by three centimeters toward the X+ direction, the control unit 12 controls the map displayed by the display unit 11 to shift by only three centimeters toward the right.

The user may select the second type of operating instructions to operate the user interface 111 in FIG. 2C, and the user interface 111 shows names of four songs. The user can make the cursor move upward or downward by moving the portable digital device upward or downward, and then the cursor can move to the song that the user wants to play. For example, when the user moves the portable digital device 1 downward, the control unit 12 calculates the distance D_{Y-} and controls the cursor to move downward by the distance D_{Y-} on the music menu shown by the user interface. When the user wants to play the song, he can move the portable digital device 1 forth/back (along the Z+/Z− direction), and then the control unit 12 can input a confirmation command on the user interface 111 according to the sensing signal and execute the executable object shown by the user interface 111.

In the embodiment, the start unit is continuously enabled to keep the intuitive browsing function started. However, in other embodiment of the invention, the second time of enabling the start unit may be used to disable the intuitive browsing function to switch between the normal operating mode and the intuitive browsing operating mode according to the requirement of the user or the supplier.

Therefore, as for the portable digital device with the intuitive browsing function and the operating method thereof, a start unit is enabled to allow the value and direction of the gravity acceleration variation to be sensed and provided for the control unit, and then the control unit operates a user interface based on the sensing signal. Thus, a user can operate the portable digital device intuitively and obtain various operating effects by varying the displacement of the portable digital device.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable digital device with an intuitive browsing function comprising:
a control unit;
a gravity accelerometer electrically connected to the control unit;
a display unit electrically connected to the control unit and capable of displaying a user interface; and
a start unit electrically connected to the control unit;
when the start unit is enabled, the gravity accelerometer continuously senses a gravity acceleration variation in a direction according to a predetermined sampling frequency to provide a sensing signal corresponding to the gravity acceleration variation for the control unit, and the control unit performs an operation on the user interface based on the sensing signal and the displacement of the portable digital device calculated based on the gravity acceleration variation.

2. The portable digital device according to claim 1, wherein the user interface shows an executable object, and the control unit is capable of executing the executable object shown by the user interface based on the sensing signal.

3. The portable digital device according to claim 1, wherein the control unit performs an operation of shifting a picture shown by the user interface based on the sensing signal.

4. The portable digital device according to claim 3, wherein the direction of shifting the picture corresponds to the direction of the gravity acceleration variation.

5. The portable digital device according to claim 3, wherein the distance of shifting the picture corresponds to the displacement of the portable digital device.

6. The portable digital device according to claim 1, wherein the control unit performs a menu scrolling on the user interface based on the sensing signal.

7. The portable digital device according to claim 1, wherein the control unit performs an operation of moving a cursor on the user interface based on the sensing signal.

8. The portable digital device according to claim 1, wherein the control unit performs an operation of rotating a picture on the user interface based on the sensing signal.

9. The portable digital device according to claim 1, wherein the control unit performs a confirmation on the user interface based on the sensing signal.

10. An operating method of a portable digital device with an intuitive browsing function, the operating method comprising the steps of:
enabling a start unit;
continuously sensing a gravity acceleration variation in a direction according to a predetermined sampling frequency;
providing a sensing signal corresponding to the gravity acceleration variation; and
operating a user interface based on the sensing signal and the displacement of the portable digital device calculated based on the gravity acceleration variation.
